(19) United States
(12) Patent Application Publication
(10) Pub. No.: US 2025/0327893 A1
(43) Pub. Date: Oct. 23, 2025

(54) SYSTEM AND METHODS FOR DETERMINING PHASE DIFFERENCE OF ARRIVAL

(71) Applicant: Qorvo US, Inc., Greensboro, NC (US)

(72) Inventors: Lisa Meilhac, Valbonne (FR); Jaroslaw Niewczas, Józefów (PL)

(21) Appl. No.: 19/088,881

(22) Filed: Mar. 24, 2025

Related U.S. Application Data
(60) Provisional application No. 63/636,624, filed on Apr. 19, 2024.

(51) Int. Cl. G01S 5/02; G01S 3/46; H04L 25/02

(52) U.S. Cl. CPC G01S 5/0284; G01S 3/46; H04L 25/0212

(57) ABSTRACT

A method for determining an angle from an ultra-wideband (UWB) device, including the following operations. A first frame fragment is received from the UWB device containing a first ternary sequence of chips by a first antenna, and another first frame fragment is received from the UWB device containing the first ternary sequence of chips by a second antenna. A first channel impulse response estimate (CIRE) is determined corresponding to the first frame fragment and another first CIRE is determined corresponding to the other first frame fragment. A phasor value is determined based on the first CIRE and the other first CIRE. A phase difference of arrival (PDoA) from the UWB device is determined based on the phasor value.

### CROSS-REFERENCE TO RELATED APPLICATION(S)

The present application claims the benefit of U.S. Provisional Application No. 63/636,624, entitled “SYSTEM AND METHODS FOR DETERMINING PHASE DIFFERENCE OF ARRIVAL,” filed on Apr. 19, 2024, which is hereby incorporated by reference in its entirety.

### FIELD OF THE DISCLOSURE

The present disclosure relates to channel estimation in ultra-wideband (UWB) communication and, in particular, to systems and methods for determining a phase difference of arrival (PDoA) in a UWB communication system.

### BACKGROUND

Ultra-wideband (UWB) is a wireless communication technology that uses a wide bandwidth, typically about 500 MHz or larger, or has a 10 dB bandwidth greater than 20% of the center frequency. In ranging operation, UWB transmitters send frames containing training/sounding sequences (e.g., in synchronization (SYNC) and/or scrambled timestamp sequence (STS) fields) which can be used by the UWB receivers to estimate ranging measures such as the time of arrival (ToA) and the PDoA. Often, the sounding sequences are used to compute channel impulse response estimates (CIREs) for extracting ranging measures. The PDoA is obtained by computing the phase difference between the CIREs obtained on two antennas of a UWB receiver.

The IEEE standards have introduced a multi millisecond (MMS) frame format. This transmission mode allows to increase the ranging range. In this MMS scheme, the sounding sequence is split over several milliseconds (ms) to cope with the energy per ms limitation defined by regulation entities such as the federal communications commission (FCC). Thus, the channel sounding operation can benefit from more energy transmitted, which increases the link budget of the operation and thus the ranging range. On the other hand, as it is spread over several ms, MMS receivers are much more sensitive to carrier and clock frequency errors/offsets.

Thus, methods and systems to estimate PDoA that is less susceptible to carrier and clock frequency errors are desired.

### SUMMARY

An aspect of the present disclosure provides a method for determining an angle from an ultra-wideband (UWB) device. The method includes: receiving, from the UWB device, a first frame fragment containing a first ternary sequence of chips by a first antenna, and another first frame fragment containing the first ternary sequence of chips by a second antenna; determining a first channel impulse response estimate (CIRE) corresponding to the first frame fragment and another first CIRE corresponding to the other first frame fragment; computing a phasor value based on the first CIRE and the other first CIRE; and determining a phase difference of arrival (PDoA) from the UWB device based on the phasor value.

In some embodiments, the method further includes: receiving, from the UWB device, a second frame fragment containing a second ternary sequence of chips by the first antenna, and another second frame fragment containing the second ternary sequence of chips by the second antenna; determining a second CIRE corresponding to the second frame fragment and another second CIRE corresponding to the other second frame fragment; computing a second phasor value based on the second CIRE and the other second CIRE; computing an accumulation of the phasor value and the second phasor value; and determining the PDoA from the UWB device based on the accumulation of the phasor value and the second phasor value.

In some embodiments, the computing of the phasor value includes: computing a conjugate of the other first CIRE; and multiplying the first CIRE with the conjugate of the other first CIRE.

In some embodiments, the multiplying of the first CIRE with the conjugate of the other first CIRE includes multiplying coefficients of the first CIRE with coefficients of the conjugate of the other first CIRE at same locations.

In some embodiments, the method further includes: computing a sum based on the first CIRE and the other first CIRE; and computing a time of arrival (ToA) based on the sum.

In some embodiments, the computing of the sum comprises: computing a first squared absolute value of the first CIRE and another first squared absolute value of the other first CIRE; and computing a sum of the first squared absolute value and the other first squared absolute value.

In some embodiments, the computing of the sum comprises: computing a first absolute value of the first CIRE and another first absolute value of the other first CIRE; and computing a sum of the first absolute value and the other first absolute value.

In some embodiments, the method further includes: receiving, from the UWB device, a second frame fragment containing a second ternary sequence of chips by the first antenna; receiving, from the UWB device, another second frame fragment containing the second ternary sequence of chips by the second antenna; and determining a second CIRE corresponding to the second frame fragment and another second CIRE corresponding to the other second frame fragment. In some embodiments, the method further includes: computing a second squared absolute value of the second CIRE and another second squared absolute value of the other second CIRE; computing a second sum of the second squared absolute value and the other second squared absolute value; computing an accumulation of the sum and second sum; and determining the ToA based on the accumulation.

In some embodiments, the determining of the PDoA further comprises: determining the tap coefficient from the accumulation of the sum and the second sum; computing an angle based on the accumulation of the phasor value and the second phasor value, and the coefficient; and computing the PDoA based on the angle.

In some embodiments, the method further includes computing a time of arrival (ToA) based on the phasor value.

In some embodiments, the method further includes: computing a squared absolute value of the phasor value; and computing the ToA based on the squared absolute value.

In some embodiments, the method further includes: computing an absolute value of the phasor value; and computing the ToA based on the absolute value.

In some embodiments, the method further includes: computing a squared absolute value of the accumulation; and computing a time of arrival (ToA) based on the absolute value.

In some embodiments, the method further includes: computing an absolute value of the accumulation; and computing a time of arrival (ToA) based on the absolute value.

In some embodiments, the method further includes compensating a clock offset and a carrier frequency offset (CFO) prior to determining the first CIRE and the other first CIRE.

In some embodiments, the method further includes: receiving a narrow band (NB) message; and estimating the clock offset and the CFO based on the NB message.

Another aspect of the present disclosure provides an ultra-wide band (UWB) device. The UWB device includes a receiver operable to perform a UWB communication and a narrow band (NB) communication; a memory for storing program instructions, cipher codes, correlation results, and channel-impulse response estimates (CIRE's) accumulated from the correlation results, phasor values, squared absolute values; and a processor coupled to the receiver and to the memory. The processor is operable to execute the program instructions, which, when executed by the processor, cause the UWB device to perform the following operations. The operations include: receiving, from another UWB device, a first frame fragment containing a first ternary sequence of chips by a first antenna, and another first frame fragment containing the first ternary sequence of chips by a second antenna; determining a first channel impulse response estimate (CIRE) corresponding to the first frame fragment and another first CIRE corresponding to the other first frame fragment; computing a phasor value based on the first CIRE and the other first CIRE; and determining a phase difference of arrival (PDoA) from the UWB device based on the phasor value.

In some embodiments, the method further includes: receiving, from the UWB device, a second frame fragment containing a second ternary sequence of chips by the first antenna, and another second frame fragment containing the second ternary sequence of chips by the second antenna; determining a second CIRE corresponding to the second frame fragment and another second CIRE corresponding to the other second frame fragment; computing a second phasor value based on the second CIRE and the other second CIRE; computing an accumulation of the phasor value and the second phasor value; and determining the PDoA from the UWB device based on the accumulation of the phasor value and the second phasor value.

In some embodiments, the computing of the phasor value includes: computing a conjugate of the other first CIRE; and multiplying the first CIRE with the conjugate of the other first CIRE.

In some embodiments, the multiplying of the first CIRE with the conjugate of the other first CIRE includes multiplying coefficients of the first CIRE with coefficients of the conjugate of the other first CIRE at same locations.

In some embodiments, the method further includes: computing a sum based on the first CIRE and the other first CIRE; and computing a time of arrival (ToA) based on the sum.

In some embodiments, the computing of the sum comprises: computing a first squared absolute value of the first CIRE and another first squared absolute value of the other first CIRE; and computing a sum of the first squared absolute value and the other first squared absolute value.

In some embodiments, the computing of the sum comprises: computing a first absolute value of the first CIRE and another first absolute value of the other first CIRE; and computing a sum of the first absolute value and the other first absolute value.

In some embodiments, the method further includes: receiving, from the UWB device, a second frame fragment containing a second ternary sequence of chips by the first antenna; receiving, from the UWB device, another second frame fragment containing the second ternary sequence of chips by the second antenna; and determining a second CIRE corresponding to the second frame fragment and another second CIRE corresponding to the other second frame fragment. In some embodiments, the method further includes: computing a second squared absolute value of the second CIRE and another second squared absolute value of the other second CIRE; computing a second sum of the second squared absolute value and the other second squared absolute value; computing an accumulation of the sum and second sum; and determining the ToA based on the accumulation.

In some embodiments, the determining of the PDoA further comprises: determining the tap coefficient from the accumulation of the sum and the second sum; computing an angle based on the accumulation of the phasor value and the second phasor value, and the coefficient; and computing the PDoA based on the angle.

In some embodiments, the method further includes computing a time of arrival (ToA) based on the phasor value.

In some embodiments, the method further includes: computing a squared absolute value of the phasor value; and computing the ToA based on the squared absolute value.

In some embodiments, the method further includes: computing an absolute value of the phasor value; and computing the ToA based on the absolute value.

In some embodiments, the method further includes: computing a squared absolute value of the accumulation; and computing a time of arrival (ToA) based on the absolute value.

In some embodiments, the method further includes: computing an absolute value of the accumulation; and computing a time of arrival (ToA) based on the absolute value.

In some embodiments, the method further includes compensating a clock offset and a carrier frequency offset (CFO) prior to determining the first CIRE and the other first CIRE.

In some embodiments, the method further includes: receiving a narrow band (NB) message; and estimating the clock offset and the CFO based on the NB message.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1 illustrates an exemplary communication system 100 having an initiator and a responder communicating using narrow-band (NB) assisted UWB communication, according to some embodiments of the present disclosure.

FIG. 2A illustrates a simplified block diagram of an exemplary receiver for PDoA and ToA computation, according to some embodiments of the present disclosure.

FIG. 2B illustrates a simplified block diagram of another exemplary receiver for PDoA and ToA computations, according to some embodiments of the present disclosure.

FIGS. 3A and 3B illustrate a flowchart of an exemplary process for PDoA and ToA computations, according to some embodiments of the present disclosure.

FIGS. 4A and 4B illustrate experimental results of PDoA and ToA computations using the receivers shown in FIGS. 2A and 2B, according to some embodiments of the present disclosure.

FIG. 5 illustrates a flowchart for a method for computing a PDA, according to some embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that the user is carrying a device capable of communicating through UWB (referred to as “UWB-enabled device” or simply as “UWB device”). In some embodiments, a UWB device is also capable of communicating through narrow band communication (e.g., +10% of 2.4 GHZ). In some embodiments, the NB signal may include one or mor of a Bluetooth signal (e.g., in the range of 2400-2483.5 MHz) or a Zigbee signal (e.g., 868 MHz, 902-928 MHz, 2.4 GHZ, 784 MHZ, and 915 MHz). The NB signal may share the same crystal/clock as the UWB such that the CFO estimation performed based on the NB signal can be used to compensate the CFO on the UWB path. In various embodiments, the NB signal may also include a signal with other suitable frequencies or frequency ranges.

In this disclosure, a symbol is a sequence of chips. Term “symbol” and term “sequence” may be used interchangeably. A chip refers to a sequence element, such as a binary number, 0, 1, or −1.

As used herein, a tap in a channel impulse response (CIR) refers to a specific path through which a signal travels from the transmitter to the receiver.

Currently in MMS scheme, a fragment of a UWB frame structure is transmitted per millisecond by a UWB transmitter. The fragment is known as a MMS fragment. Under the MMS scheme, the UWB transmitter often transmits several frame fragments, each containing at least a sounding sequence (e.g., a ternary sequence such as an Ipatov sequence). A UWB receiver (e.g., a fully-coherent MMS receiver) receives the MMS fragments, and accumulate the MMS fragments coherently, in which the carrier frequency (CFO) offset and clock frequency offsets are compensated accurately. However, the requirement in terms of CFO accuracy to get a valid estimation of the complex channel impulse response estimate (CIRE) with a basic UWB receiver architecture is difficult to achieve. The options to case this issue include the implementation of a more complex architecture such as a coherent receiver or using non-coherent UWB receivers. The coherent receiver can fully compensate the CFO between the two antennas but requires a significant amount of memory and may introduce non-negligible latency. A non-coherent UWB receiver computes an estimation of the absolute value of the CIRE instead of the complex coefficient, making it robust to CFO compensation error. The ToA can be estimated from the absolute CIRE with some sensitivity loss. However, as the phase information is lost using existing non-coherent UWB receiver, such a non-coherent UWB receiver cannot provide an estimation of the PDoA.

Another option is using a narrow band (NB) receiver to provide an estimation of the CFO and clock offset, such that the CFO and clock offset can be pre-compensated before the accumulation by the UWB receiver. The NB receiver can receive a NB message that carries data involved in the two way ranging (TWR), and indicates the start of the MMS fragments, and provide estimated clock and CFO offsets and the time of arrival of the MMS fragments. The UWB receiver can apply the estimated CFO and clock as correction, and accumulate the corrected MMS fragments blindly after receiving the NB message. A CIRE can be obtained. A ToA can be estimated based on the CIRE, and a PDoA can be estimated based on CIREs obtained from the two antennas of the UWB receiver. However, the CFO and clock offset estimation for the compensation require high accuracy, e.g., 5 parts per billion, which is difficult to achieve using the estimated clock and CFO offsets by the NB receiver.

Embodiments of the present disclosure provide receiver devices configured to estimate PDoA and ToA that are less susceptible to CFO and clock offset under the MMS scheme. The disclosure receiver devices may be non-coherent receivers. The proposed solution relaxes the requirement in terms of CFO estimation accuracy to support PDoA estimation with MMS scheme or relaxes the requirement in terms of memory if compared to the option of using a coherent receiver. The disclosed receiver devices or UWB receivers may not accumulate complex CIREs that are too sensitive to the CFO and clock offset. Instead, the disclosed UWB receivers accumulate “over fragments” channel “representations” which are independent of CFO. For instance, the UWB receivers may combine MMS fragments using absolute values of the per-fragment (e.g., single/individual fragment) CIREs, thus making the process independent of the CFO. In this disclosure, it is assumed that the CFO error is less than 1 part(s) per million (ppm).

In the UWB receivers of the present disclosure, each individual MMS fragment is accumulated fully-coherently, but the phase is not maintained between all fragments. Since each MMS fragment is relatively short, the accumulation over each individual MMS fragment reduces the CFO accuracy requirements. For example, instead of 5 parts per billion for the accumulation of all individual MMS fragments, only about 100-500 parts per billion is needed for the CFO and clock offset compensation for each individual MMS fragment, which is easily achievable. In this disclosure, respective phase information is derived from the accumulation of each individual MMS fragment, and are accumulated to obtain the phase information of all MMS fragments.

In this disclosure, the UWB receivers may estimate directly the PDoA without requiring the estimation of a complex CIRE. In an example, PDoA estimation implementation loss using the receiver devices of the present disclosure is less than 1 dB for an 8 fragments MMS scheme compared to a fully coherent receiver.

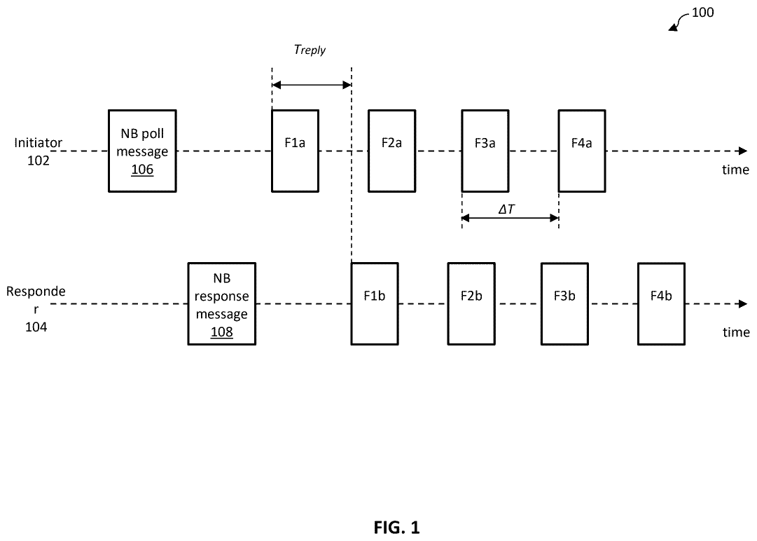

FIG. 1 illustrates a narrow band assist (NBA) MMS based TWR between an initiator 102 and a responder 104, according to some embodiments. Initiator 104 and responder 104 may both be capable of NB communication and UWB communication. Initiator 102 may transmit a NB poll message 106, followed by a plurality of MMS fragments, e.g., F1a, F2a, F3a, and F4a. Receiving NB poll message 106, responder 104 may transmit a NB response message 108, followed by MMS fragments F1b, F2b, F3b, and F4b. NB poll message 106 and/or NB response message 108 may contain data associated with the TWR in its payload. The time interval between adjacent MMS fragments may be ΔT, which may be a few milliseconds (e.g., 1 millisecond). MMS fragments F1b, F2b, F3b, and F4b may be respective replies to MMS fragments Fla, F2a, F3a, and F4a. For example, a time of reply Treply between F1b and Fla may be less than a millisecond. NB poll message 106 and NB response message 108 may be transmitted in NB, and F1a-F4a and F1b-F4b may be transmitted in UWB. In some embodiments, each of the MMS fragments (e.g., F1a-F4a, F1b-F4b) includes at least a sequence of chips, such as a ternary sequence of good autocorrelation properties (e.g., Ipatov sequence) and/or a scrambled timestamp sequence (STS).

In existing technology, the payload of NB (e.g., NB poll message 106 and/or NB response message 108) may indicate the receiver (e.g., of initiator 102 or responder 104) the start of MMS fragments (e.g., the time to start demodulation) and provide estimated correction (e.g., a coarse estimation) for CFO and clock offset. The corrected incoming signal is correlated with a reference signal (e.g., a priori known transmitted waveform). The correlation results (e.g., a plurality or all MMS fragments) are accumulated to form a complex CIRE, which is used to extract the PDoA and ToA estimates. The sensitivity (e.g., signal-to-noise ratio or SNR) of the NBA MMS based TWR may increase by about 3 dB for each doubling number of MMS fragments. However, the correction provided by the NB payload may not be sufficiently precise or accurate, such that the PDoA and ToA computed based on merely the estimated correction from the NB messages may be affected by the non-coherency of the incoming signals, and the accuracy of the PDoA and the ToA may be undesirably low.

In the present disclosure, the receivers of initiator 102 and responder 104 may compute PDoA that is less susceptible to CFO and clock offset. The details of the process are described as follows.

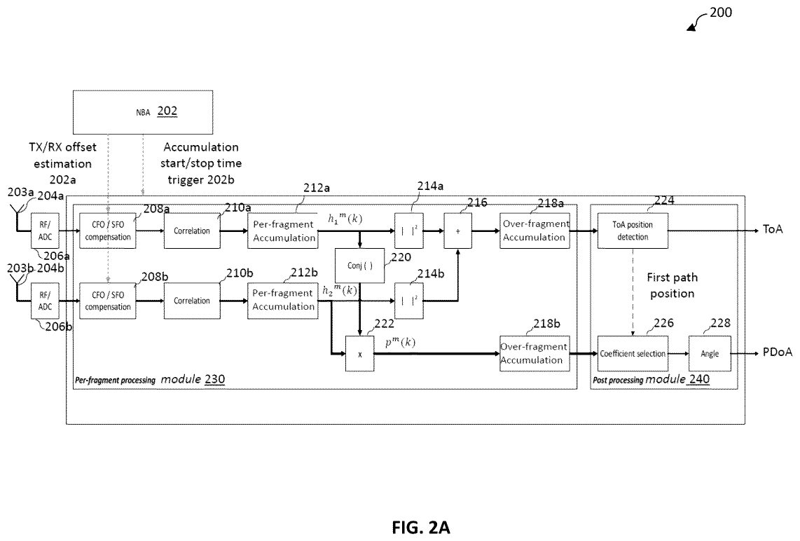

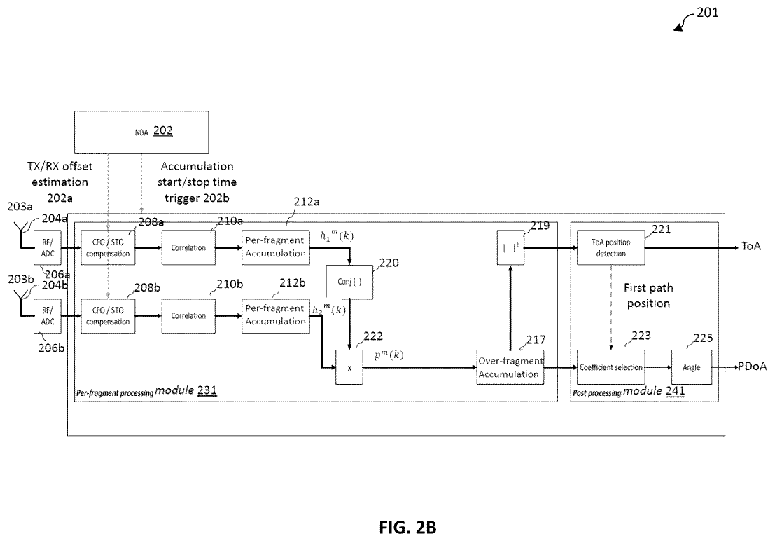

FIGS. 2A and 2B illustrate exemplary receiver devices 200 and 201 configured to determine PDoA less susceptible to CFO and clock offset, according to embodiments of the present disclosure. Receiver devices 200 and 201 may each be part of a RF device (e.g., initiator 102 and/or responder 104), and may each include any suitable hardware and/or software to implement the corresponding functions. For example, the per-fragment processing modules may be implemented in hardware eventually with certain software control, the post processing modules may be implemented in software with certain hardware accelerators. In some embodiments, receiver devices 200 and 201 may each be in the form of a chip/die, and the hardware to implement the functions of receiver devices 200 and 201 may be situated in the chip.

Receiver device 200 may include an NBA module 202, a per-fragment module 230 electrically coupled to NBA module 202, and a post processing module 240 electrically coupled to per-fragment module 230. In some embodiments, NBA module 202 may include a NBA receiver. In some embodiments, per-fragment module 230 and post processing module 240 may be part of a UWB transceiver. The UWB transceiver (or per-fragment module 230) may include two receiver paths. The first receiver path may include an antenna 204a, a CFO/SFO compensation module 208a, a correlation module 210a, and an per-fragment accumulation module 212a. The second receiver path may include an antenna 204b, a CFO/SFO compensation module 208b, a correlation module 210b, and an per-fragment accumulation module 212b.

NBA module 202 may include a NB receiver that detects the NB messages (e.g., 106 and 108), and may include a control circuit that computes a coarse estimation of TX/RX (transmitter/receiver) clock and CFO offsets 202a based on the payload of the received NB message, and informs per-fragment processing module 230 the estimation of arrival time of the MMS fragments such that per-fragment module 230 may start accumulation in time. For example, NBA module 202 may be electrically coupled to CFO/SFO compensation modules 208a and 208b to trigger the compensation of a MMS fragment using the estimated TX/RX clock and CFO offsets 202a after a NB message is received. NBA module 202 may also trigger per-fragment processing module 230 to start/stop the time to perform accumulation 202b (e.g., by modules 212a, 212b, 217 and/or 219).

As the crystal oscillators of the transmitter and the receiver are providing slightly different frequency references, the received signal (e.g., by receiver device 200) is affected by a CFO and the sampled digital signal is affected also by a SFO. NBA module may compute θₚₚₘ and transmit θₚₚₘ to CFO/SFO compensation module 208a, where θₚₚₘ is the offset estimation in ppm provided by the NB message.

Antennas 204a and 204b may each be configured to receive radio frequency (RF) signals from another device (e.g., initiator 102 or responder 104). In some embodiments, the RF signals or signals include M individual MMS fragment (e.g., Fla, F2a, . . . ) of a frame, M being a positive integer. As shown in FIG. 2A, RF/ADC 206a may receive a signal 203a and RF/ADC 206b may receive a signal 203b, where 203a and 203b are each a MMS fragment containing the same sounding sequence(s) but carry different phase information due to the different locations of antennas 204a and 204b. For example, 203a and 203b may be copies of Fla but with different phase information. In some embodiments, per-fragment processing module 231 includes two receiver paths/branches. In a first receiver path, antenna 204a may be electrically connected to a RF/ADC module 206a, and in a second receiver path, antenna 204b may be electrically connected to a RF/ADC module 206b. RF/ADC modules 206a and 206b may respectively sample the received RF signals to digital signals. RF/ADC modules 206a and 206b may each be part of a respective signal processing path, which is part of per-fragment processing module 230. In some embodiments, RF/ADS modules 206a and 206b each samples an individual MMS fragment (e.g., 203a or 203b) after it is received by the respective antenna.

In some embodiments, per-fragment processing module 231 may include an analog and radio frequency (RF) and baseband (BB) processing circuit (not shown) in each receiver path that takes the received MMS fragment and provides front-end processing (e.g., amplification, filtering, down-conversion to a BB frequency) and passes a BB signal to an in-phase/quadrature (I/Q) sampling circuit. For example, the RF and BB processing circuit may be part of RF/ADC 206a/206b. A sampled MMS fragment may be transmitted to the respective CFO/SFO (sampling frequency (or time) offset) compensation module 208a/208b.

As shown in FIG. 2A, RF/ADC 206a may be electrically coupled to a CFO/SFO compensation module 208a, which is configured to compensate/correct the CFO and/or SFO of the sampled signal (e.g., the sampled MMS fragment) using the coarse estimated CFO and clock offset provided by NBA module 202. As described, NBA module may compute θₚₚₘ and transmit θₚₚₘ to CFO/SFO compensation module 208a. CFO/SFO compensation module 208a may perform CFO and clock offset compensation to obtain a corrected sampled signal by multiplying the n^{th} sample of complex received signal (e.g., 203a or 203b) with

$$exp ( - 2 i π \cdot \frac{{f}_{c} {θ}_{ppm}}{{10}^{6} {f}_{s}} \cdot n ) ,$$

where θₚₚₘ is the offset estimation in ppm provided by the NB message, fₛ is the sampling frequency of the received signal, f_{c} is the carrier frequency of the received signal. In some embodiments, the SFO compensation can be performed vias a resampling block.

The corrected sampled signal may then be processed by a correlation module 210a. Correlation module 210a may be configured to correlate each sounding sequence in the corrected sampled signal with a known reference signal/sequence. The correlated signal may then be accumulated by a per-fragment accumulation module 212a, which is configured to accumulate the correlation result obtained from each sounding sequence in the MMS fragment. The result of the correlation and accumulation processing on the individual MMS fragment, e.g., the m^{th} MMS fragment on the 1^{st} receiver path, may be a first initial CIRE expressed as

$${\{ {h}_{1}^{m} ( k ) \}}_{k = \{ 1 , … , K \}} ,$$

K being the number of taps/coefficients of the first initial CIRE.

Similar to RF/ADC 206a, RF/ADC 206b may be electrically coupled to a CFO/SFO compensation module 208a, which is configured to compensate the sampled MMS fragment corresponding to signal 203b. Correlation module 210b may be configured to correlate each sounding sequence in the sampled signal with a known reference signal/sequence. The correlated signal may then be accumulated by a per-fragment accumulation module 212b. The result of the correlation and accumulation processing on the individual MMS fragment, e.g., the m^{th} MMS fragment on the 2nd receiver path, may be a second initial CIRE expressed as

$${\{ {h}_{2}^{m} ( k ) \}}_{k = \{ 1 , … , K \}} ,$$

K being the number of taps/coefficients of the second initial CIRE. In some embodiments, an individual MMS fragment, transmitted by another RF device, may be received by antenna 206a and 206b with difference in phase and time of arrival, and receiver device 200 may be configured to compute PDoA and ToA based on the processing of the received individual MMS fragment.

Per-fragment processing module 230 may be configured to compute a phasor value (e.g., a phasor product) p^{m}(k) for the m^{th} MMS fragment by performing a conjugation operation 220 of first initial CIRE

$${h}_{1}^{m} ( k ) ,$$

and a multiplication operation 222 between second initial CIRE first initial CIRE

$${h}_{2}^{m} ( k )$$

and the conjugate of the first initial CIRE

$${h}_{1}^{m} ( k ) .$$

Phasor value p^{m}(k) for the m^{th} MMS fragment may be computed as:

$${p}^{m} ( k ) = {h}_{2}^{m} ( k ) \times conjugate ( {{h}_{1} ( k )}^{m} ) \qquad ( 1 )$$

The multiplication may be performed by multiplying each coefficient of

$${h}_{2}^{m} ( k )$$

with each coefficient of the conjugate

$$( {h}_{2}^{m} ( k ) )$$

at the same posotions Phasor value p^{m}(k) may be stored/buffered in the memory for the m^{th} MMS fragment and used for the accumulation by over-fragment accumulation module 218b. In some embodiments, RF/ADC antennas 204a and 204b may continue to receive the rest of the M MMS fragments, and per-fragment processing module 230 may continue to compute the phasor value p^{m}(k) for each of the received MMS fragments, consecutively. In some embodiments, the computed phasor values p^{m}(k) for all MMS fragments may be stored in the memory for further computation, e.g., accumulation by over-fragment accumulation module 218b. Over-fragment accumulations module 218b may constructively accumulate over the M phasor values p^{m}(k) to obtain an accumulated phasor value q(k), e.g., fragment by fragment for the M MMS fragments:

$$q ( k ) = {\sum }_{m = 1}^{M} {p}^{m} ( k ) \qquad ( 2 )$$

In some embodiments, q(k) may contain the relative CIRE phase information between

$${h}_{1}^{m} ( k ) and {h}_{2}^{m} ( k ) .$$

The output, q(k), of over-fragment accumulations 218b may be an accumulated CIRE that is further transmitted to a coefficient selection module 226 in post processing module 240. Coefficient selection module 226 may receive a coefficient k* representing the index of tap(s) at the first path position from a ToA position detection module 224, and an angle operation 228 may be performed to determine the PDoA to be:

$$PDoA = angle ( q ( {k}^{*} ) ) \qquad ( 3 )$$

Thus, from equation (3), a PDoA estimation may be determined by obtaining the phase of the coefficient corresponding to the first path position. In some embodiments, depending on the application, coefficient selection module 226 may receive a coefficient k* representing the index of tap(s) at another path position (e.g., the second path, the third path, . . . , etc.) of the multipath. Meanwhile, receiver device 200 may also determine the ToA from first initial CIRE h₁ (k)^{m} and second initial CIRE h₂ (k)^{m}. As shown in FIG. 2A, per-fragment processing module 230 may determine a squared absolute value 214a |h₁(k)^{m}|² of first initial CIRE h₁(k)^{m} and a squared absolute value 214b |h₂(k)^{m}|² of second initial CIRE h₂ (k)^{m}. An addition operation 216 may be performed to perform a CIRE addition a^{m}(k) for the m^{th} MMS fragment:

$${a}^{m} ( k ) = {\vert {{h}_{1} ( k )}^{m} \vert}^{2} + {\vert {{h}_{2} ( k )}^{m} \vert}^{2} \qquad ( 4 )$$

In some embodiments, 214a and 214b may stand for an absolute value |h₁(k)^{m}| of first initial CIRE h₁(k)^{m} and an absolute value 214b |h₂(k) m| of second initial CIRE h₂(k)^{m}, and a CIRE addition a^{m}(k) for the m^{th} MMS fragment may be computed as a^{m}(k)=|h₁(k) m|+|h₂(k) m|.

In some embodiments, CIRE addition a^{m}(k) may be equal to any one of an absolute value |h₁(k)^{m}| of first initial CIRE h₁(k)^{m}, an absolute value 214b |h₂(k) m| of second initial CIRE h₂(k)^{m}, a squared absolute value |h₁(k) m|² of first initial CIRE h₁(k)^{m}, or a squared absolute value |h₂(k) m|² of second initial CIRE h₂(k) m. In other words, per-fragment processing module 230 may no need to perform the addition operation between the absolute values (or the squared absolute values) of first initial CIRE h₁(k)^{m} and second initial CIRE h₂(k) m.

In some embodiments, a^{m}(k) for each of the M MMS fragments may be stored/buffered after computation for accumulation by over-fragment accumulation module 218a. Over-fragment accumulations module 218a may constructively accumulate over the M CIRE additions a^{m}(k), e.g., fragment by fragment for the M MMS fragments, to obtain an accumulated CIRE addition a (k):

$$a ( k ) = {\sum }_{m = 1}^{M} {a}^{m} ( k ) \qquad ( 5 )$$

In some embodiments, a(k) or {a(k)}_{k∈{1:K}} may be the accumulated CIRE for the M MMS fragments, and may be stored or transmitted as an input to ToA position detection module 224, which may identify coefficient k*, the index of tap(s) at the first path position, from {a(k)}_{k∈{1: K}}. In some embodiments, to determine k*, ToA position detection module 224 may determine kₘₚ, i.e., the position of the main path using:

$${k}_{mp} = arg {max}_{k ∈ \{ 1 : K \}} ( \vert a ( k ) \vert ) \qquad ( 6 )$$

Equation (6) may return kₘₚ, i.e., the value of k that maximizes the value of |a(k)|, which is the absolute value of a(k). ToA position detection module 224 may then determine the first path index k* as:

$${k}^{*} = min l ∈ \{ {k}_{m p} - D : {k}_{m p} \} such that \vert a ( mod ( l , K ) ) \vert < T \qquad ( 7 )$$

In equation (7), D may be a user-defined parameter determined according to the maximum time of flight (ToF) difference between the first path and the main path, and T may be a pre-defined noise threshold determined to obtain the targeted mis-detection and false-alarm rate. ToA position detection module 224 may then compute the ToA based on k*.

Receiver device 201, as shown in FIG. 2B, may include NBA module 202, a per-fragment processing module 231 electrically coupled to NBA module 202, and a post processing module 241 electrically coupled to per-fragment processing module 231. Similar to receiver device 201, NBA device 202 may include a NBA receiver. In some embodiments, per-fragment processing module 231 and post processing module 241 may be part of a UWB transceiver. The UWB device may be similar to receiver device 200 to include two receiver paths the respectively include antennas 204a and 204b, CFO/SFO compensation modules 208a and 208b, correlation modules 210a and 210b, and per-fragment accumulation modules 212a and 212b as part of per-fragment module 231. Similar to per-fragment module 230, per-fragment module 231 may determine a first initial CIRE expressed as

$${\{ {h}_{1}^{m} ( k ) \}}_{k = \{ 1 , … , K \}} ,$$

K being the number of taps/coefficients of the first initial CIRE, for an individual MMS fragment, e.g., the m^{th} MMS fragment on the 1^{st} receiver path; and may determine a second initial CIRE expressed as

$${\{ {h}_{2}^{m} ( k ) \}}_{k = \{ 1 , … , K \}} ,$$

K being the number of taps/coefficients of the second initial CIRE, for an individual MMS fragment, e.g., the m^{th} MMS fragment on the 2^{nd} receiver path.

Similar to receiver device 200, per-fragment processing module 231 may be configured to compute a phasor value (e.g., a phasor product) p^{m}(k) for the m^{th} MMS fragment by performing a conjugation operation 220 of first initial CIRE

$${h}_{1}^{m} ( k ) ,$$

and a multiplication operation 222 between second initial CIRE first initial CIRE

$${h}_{2}^{m} ( k )$$

and the conjugate of first initial CIRE

$${h}_{1}^{m} ( k ) .$$

Phasor value p^{m}(k) for the m^{th} MMS fragment may be computed using equation (1). Phasor value p^{m}(k) may be stored/buffered in the memory for the m^{th} MMS fragment and used for the over-fragment accumulation. Different from receiver device 200, per-fragment module 231 may include a single over-fragment accumulations module 217, which is similar to over-fragment accumulations module 218b. Over-fragment accumulations module 217 may constructively accumulate over the M phasor values p^{m}(k) to obtain accumulated phasor value q(k), e.g., fragment by fragment for the M MMS fragments using equation (2).

Coefficient selection module 223 may receive a coefficient k* representing the index of tap(s) at the first path position from a ToA position detection module 221, and an angle operation 225 may be performed to determine the PDoA as equation (3).

Different from receiver device 200, per-fragment module 231 may compute a squared absolute value 219 |q(k)|² of accumulated phase value q(k) to determine coefficient k*. As shown in FIG. 2B, per-fragment processing module 231 may compute a squared absolute value of accumulated phase value q(k), which may be:

$$a ( k ) = {\vert q ( k ) \vert}^{2} \qquad ( 8 )$$

In some embodiments, 219 stands for an absolute value |q(k)| of accumulated phasor value q(k), such that a (k)=|q(k)|. In some embodiments, a (k) or {a(k)}_{k∈{1: K}} may be the accumulated CIRE for the M MMS fragments, and may be stored or transmitted as an input to ToA position detection module 221, which may identify coefficient k* using equations (6) and (7).

The operations of receiver devices 200 and 201 may be controlled by a control circuit, which may include any suitable hardware and/or software. In various embodiments, the control circuit may control the operations of the NBA module, the per-fragment processing module, and the post processing module. Receiver devices 200 and 201 may include one or more general-purpose processors and/or one or more special-purpose processors (such as digital signal processing chips, graphics acceleration processors, microcontrollers, and/or the like) to perform the functions and operations of the control circuit, the analog RF and BB circuit, the I/Q sampling circuit, CFO/SFO compensation modules, correlation modules, per-fragment accumulation modules, over-fragment accumulation modules, conjugation operation, addition operation, ToA computation, first path position determination, and/or PDoA computation. The processor(s) may process the RF signals (e.g., UWB and/or NB) received by the antennas, and output the ToA and PDoA for further processing.

The computed data, e.g., correlation results, accumulation results, conjugation results, etc., may be stored in a memory. The memory may include one or more non-transitory storage devices that can include local and/or network accessible storage, a disk drive, a drive array, an optical storage device, a solid-state storage device such as a random access memory (“RAM”) and/or a read-only memory (“ROM”), a programmable ROM, a flash-updateable ROM, and/or the like. Such storage devices may be configured to implement any appropriate data storage, including without limitation, various file systems, algorithms, initial CIR's, constructed CIRE, and/or the like.

In various embodiments, functions/operations may be stored as one or more instructions or code in the memory, such as on a computer-readable storage medium, such as RAM, ROM, FLASH, or disc drive, and executed by the processor(s). The memory may also be stored with software components including, for example, an operating system, device drivers, executable libraries, and/or other executable code, such as one or more application programs. The application programs may include computer programs, stored in the memory and executed by the processor(s) to implement various functions under the control of the operating system. In some embodiments, the processor(s) may also be configured to control the operations of the transmitter, e.g., controlling the transmission of pulses and/or power of transmitted frames.

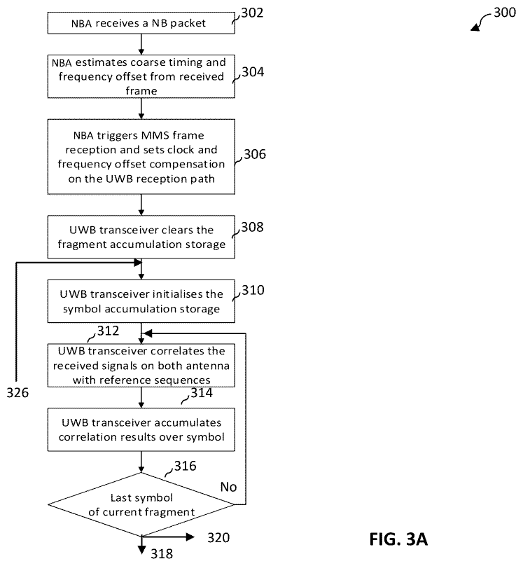

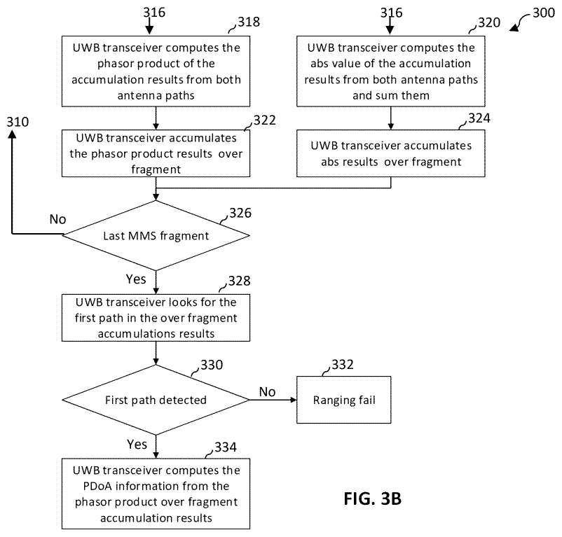

FIGS. 3A and 3B illustrate a process to determine PDoA and ToA by an exemplary receiver (e.g., 200 or 201) of the present disclosure, according to some embodiments. FIG. 3B is a continuation of FIG. 3A. For case of illustration, FIGS. 3A and 3B are illustrated in view of FIGS. 1, 2A, and 2B.

At step 302, NBA (e.g., NBA module 202) receives a NB packet (e.g., NB poll message 106). At step 304, NBA estimates coarse timing and frequency offset from the received frame. At step 306, NBA triggers MMS frame reception and sets clock and CFO compensation (e.g., 202a) on the UWB reception path(s) (e.g., the first receiver path and the second receiver path). At step 308, the UWB transceiver clears the fragment accumulation storage. In some embodiments, the UWB transceiver clears, e.g., set to zero, the memory used to store

$${h}_{1}^{m} ( k ) and {h}_{2}^{m} ( k )$$

p^{m}(k), p(k), a^{m}(k), and/or a(k). At step 310, the UWB transceiver initializes the symbol accumulation storage. In some embodiments, the UWB transceiver initializes the memory used to store the accumulation of one or more symbols/sequences in a MMS fragment. At step 312, the UWB transceiver correlates (e.g., by correlation modules 210a and 210b) the received signals on both antennas (e.g., antennas 204a and 204b) with reference signals/sequences. In some embodiments, the UWB transceiver receives a MMS fragment, compensates and correlates a symbol/sequence in the MMS fragment, and stores the correlation result. At step 314, the UWB transceiver accumulates (e.g., by per-fragment accumulation modules 212a and 212b) correlation results over the current symbol/sequence. At step 316, the UWB transceiver determines whether the last symbol of the current MMS fragment. If no, process 300 proceeds to step 312. If yes, process 300 proceeds to steps 318 and 320. In some embodiments, if yes, the correlation and accumulation of the current MMS fragment is completed, and initial CIRE's

$${h}_{1}^{m} ( k ) , {h}_{2}^{m} ( k ) ,$$

of the current MMS fragment may be computed from accumulation. The UWB transceiver starts computing the phasor value associated with the current MMS fragment.

At step 318, the UWB transceiver computes the phasor product/value of the accumulation results from both antenna paths. In some embodiments, the UWB transceiver computes phasor value p^{m}(k) of the current MMS fragment is computed. At step 322, the UWB transceiver accumulates (e.g., by over-fragment accumulations module 218a, 218b, or 217) the phasor product results over fragment, e.g., constructively fragment by fragment. In some embodiments, the UWB transceiver accumulates the phasor values with any previous phasor values (e.g., phasor values obtained and stored for previous MMS fragments). At step 326, the UWB transceiver determines whether the current MMS fragment (e.g., the m′h MMS fragment) is the last MMS fragment. If yes, process 300 proceeds to step 328. If no, process 300 proceeds to step 310, at which the UWB transceiver initializes for the correlation and accumulation of symbols/sequences in a next MMS fragment. At step 328, the UWB transceiver looks for (e.g., searches for) the first path in the over fragment accumulation results. In some embodiments, ToA position detection module (224 or 221) determines the coefficient k*. At step 330, the UWB transceiver determines whether the first path is detected. If yes, process 300 proceeds to step 334. In some embodiments, if yes, the UWB transceiver obtains q(k) using equation (2). If no, process 300 proceeds to step 332, at which the UWB transceiver determines that ranging fails. At step 334, the UWB transceiver computes the PDoA information from the phasor product over fragment accumulation results. In some embodiments, the UWB transceiver computes the PDoA using equation (3).

In some embodiments, steps 320 and 324 are performed by receiver device 200, and not by receiver device 201. At step 320, the UWB transceiver computes the absolute value of the accumulation results from both antenna paths and sum them. In some embodiments, the UWB transceiver determines a CIRE addition a^{m}(k) using equation (4). At step 324, the UWB transceiver accumulates absolute results over fragment. In some embodiments, the UWB transceiver determines an accumulated CIRE addition a (k) using equation (5). Process 300 may proceed to step 326.

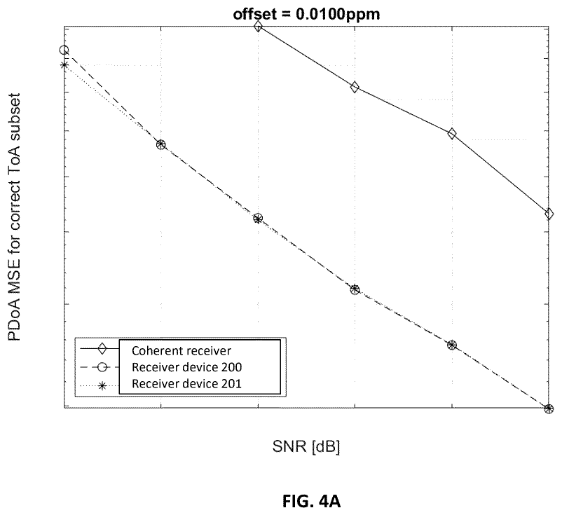

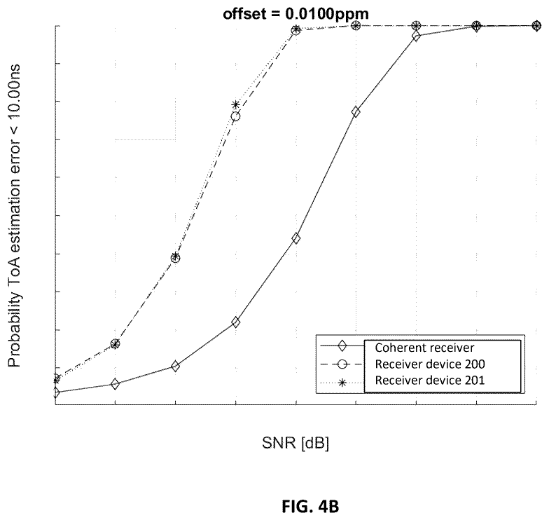

FIGS. 4A and 4B presents performance with a CFO error of 0.01 ppm. FIG. 4A shows the mean squared error (MSE) of PDoA computed based on 8 MMS fragments by a coherent receiver, receiver device 200, and receiver device 201, respectively, as a function of signal-to-noise ratio (SNR). FIG. 4B shows the probability of estimation error of ToA computed by a coherent receiver, receiver device 200, and receiver device 201, respectively, as a function of SN). As previously described, CFO and clock offset may not be fully compensated by the CFO/SFO compensation modules using the estimated compensation determined by the NBA module. Because the estimation of the compensation (e.g., computed by NBA module 202) may not be perfect, an estimation error, e.g., the CFO error, may remain in the processing. FIG. 4A shows that at the same SNR, the MSE's of the PDoA's computed using receiver device 200 or 201 are lower than that computed by a coherent receiver. FIG. 4B shows that at the same SNR, the probability of ToA estimation error being less than 10 ns is lower using receiver device 200 or 201 than a coherent receiver. FIGS. 4A and 4B show that the performance of the non-coherent receiver (e.g., receiver devices 200 and 201) is better or more robust, e.g., being less susceptible to CFO error, compared to the performance of the coherent receiver.

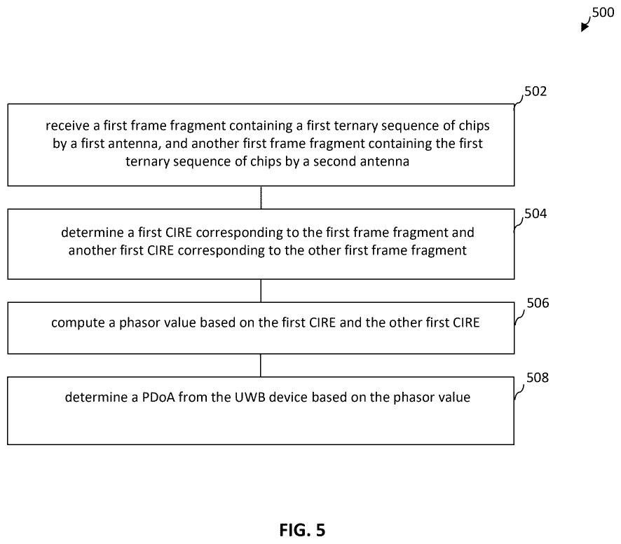

FIG. 5 is a flowchart of a method 500 for determining a PDoA by a receiver device (e.g., 200 or 201), according to some embodiments of the present disclosure. Method 500 is merely an example, and is not intended to limit the present disclosure beyond what is explicitly recited in the claims. Additional operations can be provided before, during, and after the method 500, and some operations described can be replaced, eliminated, or moved around for additional embodiments of method 500. For ease of illustration, FIG. 5 is described in connection with FIGS. 2A, 2B.

At step 502, the receiver device (e.g., 200 or 201) may receive a first frame fragment (e.g., Fla) containing a first ternary sequence of chips by a first antenna (e.g., 204a), and another first frame fragment (e.g., Fla′) containing the first ternary sequence of chips by a second antenna (e.g., 204b);

At step 504, determining a first channel impulse response estimate (CIRE) corresponding to the first frame fragment (e.g., h₁^{m}(k)) and another first CIRE corresponding to the other first frame fragment (e.g., h₂^{m}(k));

At step 506, computing a phasor value (e.g., p^{m}(k)) based on the first CIRE and the other first CIRE; and

At step 508, determining a phase difference of arrival (PDoA) from the UWB device based on the phasor value.

Those skilled in the art will recognize improvements and modifications to the preferred embodiments of the present disclosure. All such improvements and modifications are considered within the scope of the concepts disclosed herein and the claims that follow.

1. A method for determining a relative location of an ultra-wideband (UWB) device, comprising:
receiving, from the UWB device, a first frame fragment containing a first ternary sequence of chips by a first antenna, and another first frame fragment containing the first ternary sequence of chips by a second antenna;
determining a first channel impulse response estimate (CIRE) corresponding to the first frame fragment and another first CIRE corresponding to the other first frame fragment;
computing a phasor value based on the first CIRE and the other first CIRE; and
determining a phase difference of arrival (PDoA) from the UWB device based on the phasor value.

2. The method of claim 1, further comprising:
receiving, from the UWB device, a second frame fragment containing a second ternary sequence of chips by the first antenna, and another second frame fragment containing the second ternary sequence of chips by the second antenna;
determining a second CIRE corresponding to the second frame fragment and another second CIRE corresponding to the other second frame fragment;
computing a second phasor value based on the second CIRE and the other second CIRE;
computing an accumulation of the phasor value and the second phasor value; and
determining the PDoA from the UWB device based on the accumulation of the phasor value and the second phasor value.

3. The method of claim 1, wherein the computing of the phasor value comprises:
computing a conjugate of the other first CIRE; and
multiplying the first CIRE with the conjugate of the other first CIRE.

4. The method of claim 3, wherein the multiplying of the first CIRE with the conjugate of the other first CIRE comprises multiplying coefficients of the first CIRE with coefficients of the conjugate of the other first CIRE at same locations.

5. The method of claim 1, further comprising:
computing a sum based on the first CIRE and the other first CIRE; and
computing a time of arrival (ToA) based on the sum.

6. The method of claim 5, wherein the computing of the sum comprises:
computing a first squared absolute value of the first CIRE and another first squared absolute value of the other first CIRE; and
computing a sum of the first squared absolute value and the other first squared absolute value.

7. The method of claim 5, wherein the computing of the sum comprises:
computing a first absolute value of the first CIRE and another first absolute value of the other first CIRE; and
computing a sum of the first absolute value and the other first absolute value.

8. The method of claim 5, further comprising:
receiving, from the UWB device, a second frame fragment containing a second ternary sequence of chips by the first antenna;
receiving, from the UWB device, another second frame fragment containing the second ternary sequence of chips by the second antenna;
determining a second CIRE corresponding to the second frame fragment and another second CIRE corresponding to the other second frame fragment;
computing a second squared absolute value of the second CIRE and another second squared absolute value of the other second CIRE;
computing a second sum of the second squared absolute value and the other second squared absolute value;
computing an accumulation of the sum and second sum; and
determining the ToA based on the accumulation.

9. The method of claim 5, wherein the determining of the PDoA further comprises:
determining the tap coefficient from the accumulation of the sum and the second sum;
computing an angle based on the accumulation of the phasor value and the second phasor value, and the coefficient; and
computing the PDoA based on the angle.

10. The method of claim 1, further comprising computing a time of arrival (ToA) based on the phasor value.

11. The method of claim 10, further comprising:
computing a squared absolute value of the phasor value; and
computing the ToA based on the squared absolute value.

12. The method of claim 10, further comprising:
computing an absolute value of the phasor value; and
computing the ToA based on the absolute value.

13. The method of claim 2, further comprising:
computing a squared absolute value of the accumulation; and
computing a time of arrival (ToA) based on the absolute value.

14. The method of claim 2, further comprising:
computing an absolute value of the accumulation; and
computing a time of arrival (ToA) based on the absolute value.

15. The method of claim 1, further comprising compensating a clock offset and a carrier frequency offset (CFO) prior to determining the first CIRE and the other first CIRE.

16. The method of claim 1, further comprising:
receiving a narrow band (NB) message; and
estimating the clock offset and the CFO based on the NB message.

17. An ultra-wide band (UWB) device, comprising:
a receiver operable to perform a UWB communication and a narrow band (NB) communication;
a memory for storing program instructions, cipher codes, correlation results, and channel-impulse response estimates (CIRE's) accumulated from the correlation results, phasor values, squared absolute values; and
a processor coupled to the receiver and to the memory, wherein the processor is operable to execute the program instructions, which, when executed by the processor, cause the UWB device to perform the following operations:
receiving, from another UWB device, a first frame fragment containing a first ternary sequence of chips by a first antenna, and another first frame fragment containing the first ternary sequence of chips by a second antenna;
determining a first channel impulse response estimate (CIRE) corresponding to the first frame fragment and another first CIRE corresponding to the other first frame fragment;
computing a phasor value based on the first CIRE and the other first CIRE; and
determining a phase difference of arrival (PDoA) from the UWB device based on the phasor value.

18. The UWB device of claim 17, wherein the operations further comprise:
receiving, from the UWB device, a second frame fragment containing a second ternary sequence of chips by the first antenna, and another second frame fragment containing the second ternary sequence of chips by the second antenna;
determining a second CIRE corresponding to the second frame fragment and another second CIRE corresponding to the other second frame fragment;
computing a second phasor value based on the second CIRE and the other second CIRE;
computing an accumulation of the phasor value and the second phasor value; and
determining the PDoA from the UWB device based on the accumulation of the phasor value and the second phasor value.

19. The UWB device of claim 17, wherein the computing of the phasor value comprises:
computing a conjugate of the other first CIRE; and
multiplying the first CIRE with the conjugate of the other first CIRE.

20. The UWB device of claim 19, wherein the multiplying of the first CIRE with the conjugate of the other first CIRE comprises multiplying coefficients of the first CIRE with coefficients of the conjugate of the other first CIRE at same locations.
